(19) United States
(12) Patent Application Publication
(10) Pub. No.: US 2004/0003701 A1
(43) Pub. Date: Jan. 8, 2004

(54) Guitar assembly

(76) Inventor: Paul F. Van Epps, Spencerport, NY (US)

Correspondence Address: HOWARD J. GREENWALD P.C., 349 W. COMMERCIAL STREET SUITE 2490, EAST ROCHESTER, NY, 14445-2408, US

(21) Appl. No.: 10/614,562

(22) Filed: Jul. 7, 2003

Related U.S. Application Data
(60) Provisional application No. 60/394,382, filed on Jul. 8, 2002.

(51) Int. Cl. G10D 3/02

(52) U.S. Cl. 84/294

(57) ABSTRACT

A guitar assembly comprised of a neck, a string disposed on said neck, and a resonator. The neck is disposed within and attached to the resonator. The string is disposed on the neck, a portion of the string is disposed within the resonator, and a portion of the string extends through the resonator. At least three chromatic frets are disposed on the neck.

### CROSS-REFERENCE TO RELATED PATENT APPLICATION

This patent application claims priority based upon applicant's provisional patent application U.S. Ser. No. 60/394,382, filed on Jul. 8, 2002.

### FIELD OF THE INVENTION

A guitar assembly comprised of a string disposed within and passing through a resonator.

### BACKGROUND OF THE INVENTION

Guitar assemblies comprised of resonators are well known to those skilled in the art. The function of the resonator is to accoustically amplify the sound produced by the guitar string(s).

Some of the prior art guitar assemblies are complicated, cumbersome, and expensive; and, notwithstanding their structure, do not produce an excellent tone when played.

It is an object of this invention to provide a guitar assembly that is relatively uncomplicated, easy to manufacture, inexpensive, and that also produces an excellent tone.

### SUMMARY OF THE INVENTION

In accordance with this invention, there is provided a guitar assembly comprised of a neck, a string disposed on said neck, and a resonator. The neck is disposed within and attached to the resonator. The string is disposed on the neck, a portion of the string is disposed within the resonator, and a portion of the string extends through the resonator. At least three chromatic frets are disposed on the neck.

### BRIEF DESCRIPTION OF THE DRAWINGS

The invention will be described by reference to the following drawings, in which like numerals refer to like elements, and in which:

FIG. 1 is a partial perspective view of one preferred guitar assembly of the invention;

FIG. 2 is another perspective view of the guitar assembly of FIG. 1;

FIG. 3 is a partial top view of the guitar assembly of FIG. 1; and

FIG. 4 is a partial bottom view of the guitar assembly of FIG. 1.

### DESCRIPTION OF THE PREFERRED EMBODIMENTS

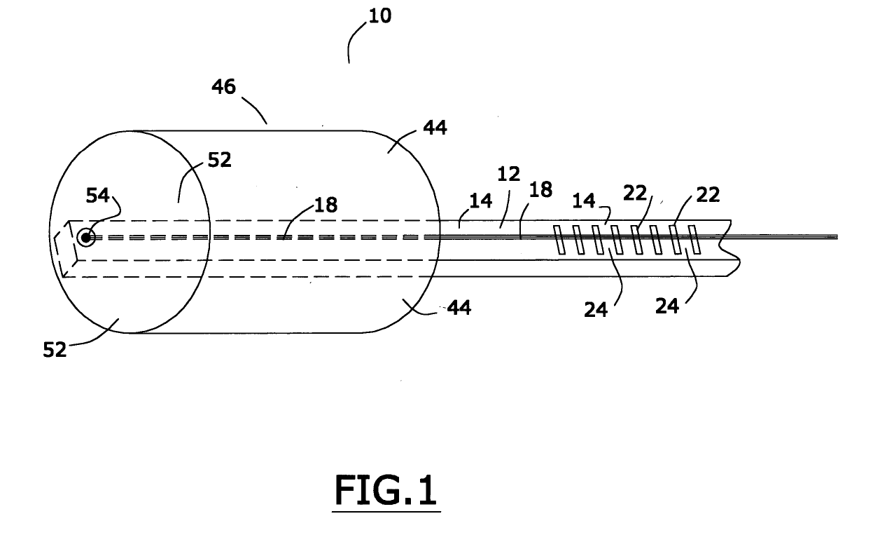

One of the preferred embodiments of this invention is a one-string guitar 10 that is illustrated, e.g., in FIG. 1. This guitar 10 is preferably comprised of a solid, elongated wooden neck 12.

In the embodiment depicted in FIG. 1, neck 12 is solid. In another embodiment, not shown, neck 12 is hollow.

In the embodiment depicted in FIG. 1, neck 12 has a substantially square cross-sectional shape. In another embodiment, not shown, neck 12 has a rectangular cross-sectional shape. In yet another embodiment, neck 12 has a semicircular cross-sectional shape. It is preferred that, regardless of the cross-sectional shape used for neck 12, that its top surface 14 is flat.

In the embodiment depicted, neck 12 preferably has a length of from about 30 to about 40 inches and, in one embodiment, from about 31 to about 35 inches. In the embodiment depicted, the height and width of neck 12 are from about 0.5 to about 1.5 inches.

In one embodiment, the neck 12 is made from a hardwood such as, e.g., poplar wood, oak, maple, and the like. In another embodiment, the neck 12 is made from a soft wood, such as pine wood.

In one preferred embodiment, the surfaces of neck 12 are coated with a wood finishing agent such as, e.g., wood lacquer, polyurethane, etc.

Affixed to the top surface of the neck 14 is a means 16 for tuning the guitar 10 and, in particular, tuning the string 18.

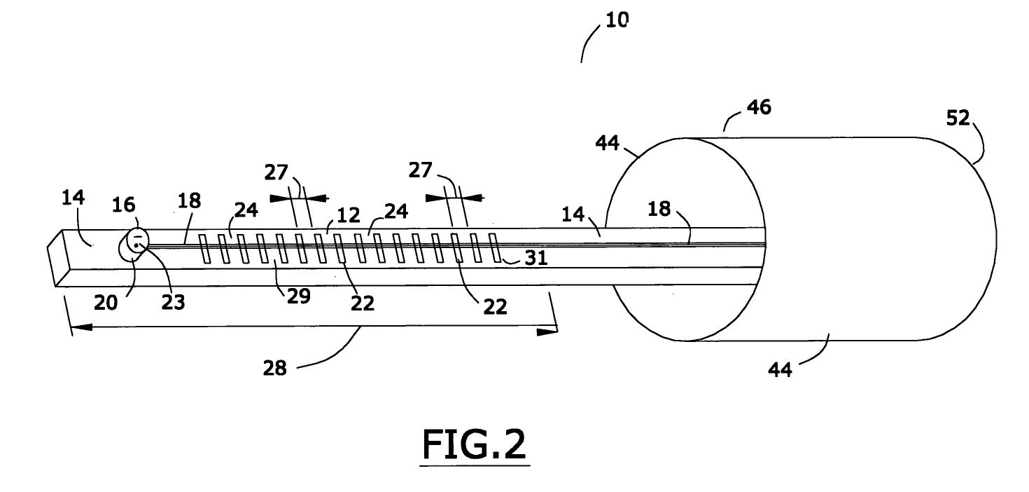

In the embodiment depicted in FIG. 2, the tuning means 16 comprises a screw 20 through which an orifice (not shown) extends. The distal end (not shown) of string 18 extends through such orifice. When the screw 20 is rotated, it will either tighten the string 18 (when rotated clockwise), or loosen the string 18 (when rotated counterclockwise).

One may use other tuning means 16. Tuning keys, and other mechanical devices for tuning guitar strings, are well known. Reference may be had, e.g., to U.S. Pat. Nos. 5,750,910, D331,769, 6,172,287, D411,856, 5,814,745, 4,860,627, 4,779,506, 4,549,461, D280,524, D280,523, and the like. The entire disclosure of each of these United States patents is hereby incorporated by reference into this specification.

Referring again to FIG. 1, guitar frets 22 may be attached to fret surface 24 prior to the time the guitar string 18 is attached. One may use any conventional guitar frets. Reference may be had, e.g., to U.S. Pat. Nos. 6,143,967 and 5,097,737, the entire disclosure of each of which is hereby incorporated by reference into this specification.

It is preferred that at least 3 such frets 22 be disposed on the top surface 24 of the neck and underneath string 18. In one embodiment, from about 3 to about 18 such frets are disposed on the surface 24. In another embodiment, from about 9 to about 15 such frets are disposed on the surface 24.

In the embodiment depicted, all of the frets 22 are preferably disposed in the proximal half 25 of the neck 12. Furthermore, in one preferred aspect of this embodiment, the spacing 27 between adjacent frets 22 gets progressively smaller as one progresses from point 29 to point 31 on the neck 12. In one embodiment, and progressing from point 31 to point 29, the spacing 27 between adjacent frets progressively becomes 1/18″ larger.

In the embodiment depicted in the Figures, at least one guitar string 18 is disposed over the guitar frets 22. In one embodiment, only one such guitar string 18 is used in the assembly 10. In another embodiment, not shown, 3 such guitar strings 18 are used in the assembly 10.

The guitar string(s) 18 is disposed over the guitar frets 22. One may use any of the guitar strings known to those skilled in the art. Reference may be had, e.g., to U.S. Pat. Nos. 6,172,287, 5,753,838, 4,798,119, 4,096,780, 3,854,368, 6,118,057, 5,913,257, 5,760,321, 5,477,764, and the like. The entire disclosure of each of these United States patents is hereby incorporated by reference into this specification.

FIG. 2 is a partial perspective view of a one-string guitar 10 which is similar to the guitar 10 depicted in FIG. 1 but illustrates the tuning mechanism 16.

Referring again to FIG. 1, and in the preferred embodiment depicted therein, it will be seen that the neck 12 extends to the bottom 52 of metal can 46, but not through it. By comparison, the string 18 extends to and through the bottom surface 52 of the metal can 46 and is secured at its end by a string ball end 54.

The metal can 46 is but one type of hollow resonator that may be used in the apparatus of this invention. Other suitable hollow resonators include, e.g., plastic cups (not shown).

In the embodiment illustrated, the metal can preferably has a cylindrical shape. One may use hollow resonators with other shapes such as, e.g., a square shape, a rectangular shape, and oval shape, an irregular shape, etc. In one embodiment, a crushed metal can (not shown) is used as the resonator 46.

The term metal can, as used in this can, includes any can that is comprised of a metal or a metal alloy. In one embodiment, the metal can 56 is a tin can.

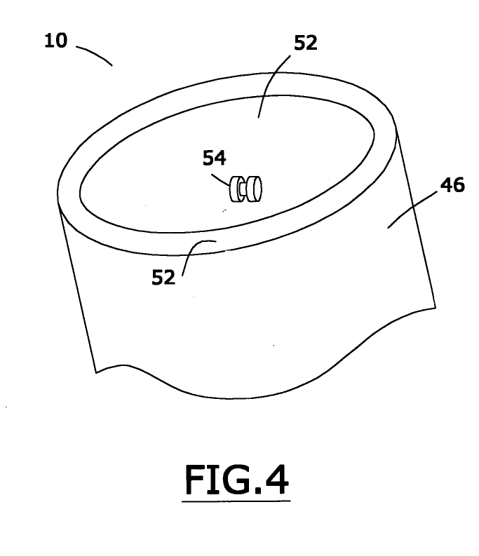

In one embodiment, illustrated in FIGS. 1, 3, and 4, the guitar string 18 is passed through an orifice and secured with metal fastener 54.

Thus, referring to FIG. 1, it will be seen that string 18 extends through the bottom surface 52 and is secured at said bottom surface 52 by fastener 54. Fastener 54, in the embodiment depicted, is a ball end metal fastener. As will be apparent, other metal fasteners also may be used.

After the guitar string 18 has been attached and secured, the neck 12 may be finished by conventional means. Alternatively, one may finish such neck 12 prior to attaching any of the hardware. In one embodiment, the neck 12 is stained and finished with polyurethane.

In the embodiment depicted in FIGS. 1, 3, and 4, is contiguous with the bottom wall 52 of the can 46. This facilitates the transmission of vibration from the string 18 to the can 46. As will be apparent, in the embodiments depicted, the can 46 functions as resonator.

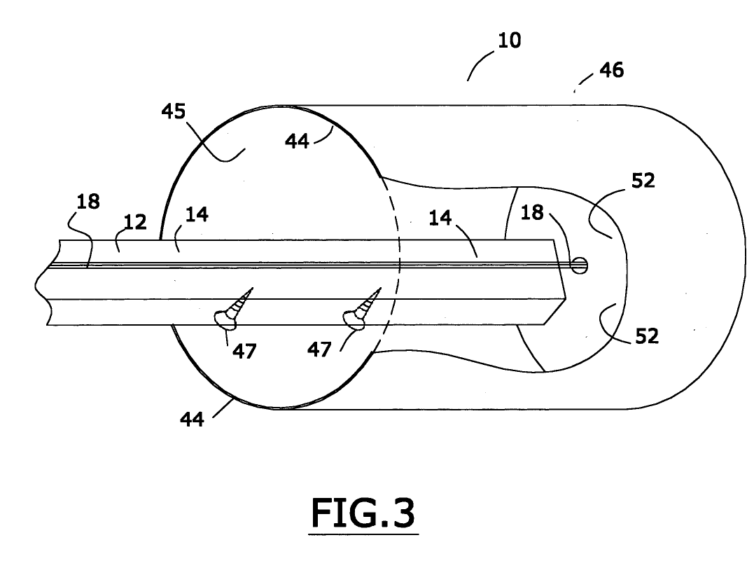

Referring again to FIG. 3, and in preferred embodiment best illustrated therein, it will be seen that a portion of the neck 12 is contiguous with the inner wall 45 of the can 46 and is secured thereto by means of a fastener 47 extending through inner wall 45 and into neck 12. In the embodiment depicted, fastener 47 is a wood screw.

It is to be understood that the aforementioned description is illustrative only and that changes can be made in the apparatus, in the ingredients and their proportions, and in the sequence of combinations and process steps, as well as in other aspects of the invention discussed herein, without departing from the scope of the invention.

I claim:

1. A guitar assembly comprised of a neck, a string disposed on said neck, and a resonator, wherein:
(a) said resonator is comprised of a cavity defined by an inner wall of said resonator,
(b) said neck is disposed within said cavity and is attached to and contiguous with said inner wall of said resonator;
(c) said string is disposed on the neck, a first portion of said string is disposed within said resonator, and a portion of said string extends through said resonator, and
(d) at least three chromatic frets are disposed on said neck.

2. The guitar assembly as recited in claim 1, wherein said neck consists essentially of wood.

3. The guitar assembly as recited in claim 2, wherein said neck has a substantially square cross sectional shape.

4. The guitar assembly as recited in claim 1, wherein said neck has a length of from about 30 to about 40 inches.

5. The guitar assembly as recited in claim 2, wherein said wood is a hardwood.

6. The guitar assembly as recited in claim 5, wherein said hardwood is selected from the group consisting of poplar wood, oak wood, and maple wood.

7. The guitar assembly as recited in claim 2, wherein said wood is a soft wood.

8. The guitar assembly as recited in claim 2, wherein said neck is comprised of a coating disposed on said neck.

9. The guitar assembly as recited in claim 8, wherein said coating is a polyurethane coating.

10. The guitar assembly as recited in claim 1, further comprising a means for tuning said string.

11. The guitar assembly as recited in claim 10, wherein said means for tuning said string is comprised of a screw.

12. The guitar assembly as recited in claim 1, wherein from about 9 to about 15 of said frets are disposed on said neck.

13. The guitar assembly as recited in claim 12, wherein said resonator is a metal can.

14. The guitar assembly as recited in claim 13, wherein said resonator is comprised of a bottom wall and a side wall.

15. The guitar assembly as recited in claim 14, wherein said resonator has a substantially cylindrical shape.

16. The guitar assembly as recited in claim 15, further comprising means for connecting a portion of said string 18 to said bottom wall of said metal can.

17. The guitar assembly as recited in claim 16, further comprising a ball end fastener contiguous with said string 18 and said bottom wall of said metal can.
